(19) United States
(12) Patent Application Publication
(10) Pub. No.: US 2025/0031275 A1
(43) Pub. Date: Jan. 23, 2025

(54) FIRST WIRELESS COMMUNICATION DEVICE AND SECOND WIRELESS COMMUNICATION DEVICE

(71) Applicant: FUJITSU LIMITED, Kawasaki-shi (JP)

(72) Inventors: Yoshiaki OHTA, Yokohama (JP); YOSHIHIRO KAWASAKI, Kawasaki (JP); Tetsuya YANO, Yokohama (JP); Takako HORI, Sagamihara (JP)

(73) Assignee: FUJITSU LIMITED, Kawasaki-shi (JP)

(21) Appl. No.: 18/892,647

(22) Filed: Sep. 23, 2024

Related U.S. Application Data
(63) Continuation of application No. PCT/JP2022/015818, filed on Mar. 30, 2022.

(51) Int. Cl. H04W 76/38; H04W 76/27

(52) U.S. Cl. CPC H04W 76/38; H04W 76/27

(57) ABSTRACT

A first wireless communication device includes a controller configured to: operate in a first mode or a second mode, the first mode being a mode that has a first mode in which data communication with a second wireless communication device may be performed, the second mode being a mode in which limited data communication may be performed; and transmit, at timing when the second wireless communication device may receive data in the second mode, a code related to message authentication and first data, to the second wireless communication device via a downlink channel, by allocating the code related to message authentication and the first data to the downlink channel that does not accompany a corresponding uplink channel.

### CROSS-REFERENCE TO RELATED APPLICATION

This application is a continuation application of International Application PCT/JP2022/015818 filed on Mar. 30, 2022 and designated the U.S., the entire contents of which are incorporated herein by reference.

### FIELD

The embodiments discussed herein are related to a first wireless communication device and a second wireless communication device.

### BACKGROUND

A plurality of states is defined for a terminal device in a wireless communication system in connecting to a base station device. The terminal device has, for example, an RRC_INACTIVE state (temporarily stopped state) and the like in addition to an RRC_CONNECTED state (communicating state) and an RRC_IDLE state (unconnected state).

The terminal device achieves power saving by turning off a radio unit in the RRC_INACTIVE state. In the RRC_INACTIVE state, the terminal device turns on the radio unit at timing of, for example, reception of paging (e.g., radio access network (RAN) paging), and receives the paging. The paging is a message for calling the terminal device. Furthermore, when the radio unit is turned on for the paging reception, the terminal device performs measurement to aggregate the timing at which the radio unit is turned on, and suppresses the power consumption caused by turning on/off of the radio unit.

When uplink small data transmission (SDT) is triggered in the RRC_INACTIVE state, the terminal device transmits data using, for example, any one of three schemes. The small data includes, for example, a small amount of data of several bytes to several hundred bytes. The three schemes are, for example, a 4-step random-access channel (RACH) scheme, a 2-step RACH scheme, and a configured grant scheme.

Techniques related to the SDT of the terminal device are disclosed in the following related art documents.

3GPP TS36.133 LTE-A Radio Measurement Specification, 3GPP TS36.300 LTE-A General Specification, 3GPP TS36.211 LTE-A PHY Channel Specification, 3GPP TS36.212 LTE-A PHY Coding Specification, 3GPP TS36.213 LTE-A PHY Procedure Specification, 3GPP TS36.214 LTE-A PHY Measurement Specification, 3GPP TS36.321 LTE-A MAC Specification, 3GPP TS36.322 LTE-A RLC Specification, 3GPP TS36.323 LTE-A PDCP Specification, 3GPP TS36.331 LTE-A RRC Specification, 3GPP TS36.413 LTE-A S1 Specification, 3GPP TS36.423 LTE-A X2 Specification, 3GPP TS36.425 LTE-A Xn Specification, 3GPP TR36.912 NR Radio Access Overview, 3GPP TR38.913 NR Requirements, 3GPP TR38.801 NR Network Architecture Overview, 3GPP TR38.802 NR PHY Overview, 3GPP TR38.803 NR RF Overview, 3GPP TR38.804 NR L2 Overview, 3GPP TR38.900 NR High Frequency Overview, 3GPP TS38.300 NR General Specification, 3GPP TS37.340 NR Multiple Access General Specification, 3GPP TS38.201 NR PHY Specification General Specification, 3GPP TS38.202 NR PHY Service General Specification, 3GPP TS38.211 NR PHY Channel Specification, 3GPP TS38.212 NR PHY Coding Specification, 3GPP TS38.213 NR PHY Data Channel Procedure Specification, 3GPP TS38.214 NR PHY Control Channel Procedure Specification, 3GPP TS38.215 NR PHY Measurement Specification, 3GPP TS38.321 NR MAC Specification, 3GPP TS38.322 NR RLC Specification, 3GPP TS38.323 NR PDCP Specification, 3GPP TS37.324 NR SDAP Specification, 3GPP TS38.331 NR RRC Specification, 3GPP TS38.401 NR Architecture General Specification, 3GPP TS38.410 NR Core Network General Specification, 3GPP TS38.413 NR Core Network AP Specification, 3GPP TS38.420 NR Xn Interface General Specification, 3GPP TS38.423 NR XnAP Specification, 3GPP TS38.470 NR F1 Interface General Specification, and 3GPP TS38.473 NR F1AP Specification are disclosed as related art.

However, a transmission scheme when downlink small data is generated in the base station device for the terminal device in the RRC_INACTIVE state is being discussed in a standardization meeting and the like.

For example, it is conceivable that the terminal device transitions from the RRC_INACTIVE state to the RRC_CONNECTED state by executing a series of procedures and transmits small data after the state transition. However, in this case, the small data may not be efficiently transmitted due to the processing of turning on the radio unit in the terminal device, the execution of the series of procedures for the state transition, and the like.

In view of the above, one disclosure provides a first wireless communication device and a second wireless communication device that efficiently execute small data transmission to a terminal device in an RRC_INACTIVE state.

### SUMMARY

According to an aspect of the embodiments, there is provided a first wireless communication device includes a controller configured to: operate in a first mode or a second mode, the first mode being a mode that has a first mode in which data communication with a second wireless communication device may be performed, the second mode being a mode in which limited data communication may be performed; and transmit, at timing when the second wireless communication device may receive data in the second mode, a code related to message authentication and first data, to the second wireless communication device via a downlink channel, by allocating the code related to message authentication and the fist data to the downlink channel that does not accompany a corresponding uplink channel.

The object and advantages of the disclosure will be realized and attained by means of the elements and combinations particularly pointed out in the claims.

It is to be understood that both the foregoing general description and the following detailed description are exemplary and explanatory and are not restrictive of the disclosure.

### BRIEF DESCRIPTION OF DRAWINGS

FIG. 1 is a diagram illustrating exemplary wireless communication in a wireless communication system 3;

FIG. 2 is a diagram illustrating an exemplary configuration of a wireless communication system 10;

FIG. 3 is a diagram illustrating an exemplary configuration of a terminal device 100;

FIG. 4 is a diagram illustrating an exemplary configuration of a base station device 200;

FIG. 5 is a diagram illustrating an exemplary paging cycle of the terminal device 100 in an RRC_INACTIVE state;

FIG. 6 is a diagram illustrating an exemplary sequence of a first scheme;

FIG. 7 is a diagram illustrating an exemplary sequence of a second scheme;

FIG. 8 is a diagram illustrating an exemplary sequence of the second scheme;

FIG. 9 is a diagram illustrating an exemplary sequence of a third scheme;

FIG. 10 is a diagram illustrating an exemplary sequence of the third scheme;

FIG. 11 is a diagram illustrating exemplary semi-persistent scheduling (SPS)-triggered data transmission;

FIG. 12 is a diagram illustrating an exemplary paging cycle according to a downlink SDT scheme;

FIG. 13 is a diagram illustrating an exemplary SPS period according to the downlink SDT scheme;

FIG. 14 is a diagram illustrating exemplary calculation formulae of a hybrid automatic repeat request process identification (HARQ process ID); and

FIG. 15 is a diagram illustrating an exemplary configuration of a new downlink common control channel (New DL CCCH).

### DESCRIPTION OF EMBODIMENTS

### First Embodiment

A wireless communication system 3 includes a first wireless communication device 1 and a second wireless communication device 2. The first wireless communication device 1 and the second wireless communication device 2 are in wireless connection with each other, and wirelessly exchange data. The first wireless communication device 1 and the second wireless communication device 2 support a first mode and a second mode.

The first wireless communication device 1 includes a first processor. The first processor executes a program stored in the first wireless communication device 1 to construct a control unit. In addition, the second wireless communication device 2 includes a second processor. The second processor executes a program stored in the second wireless communication device 2 to construct a second control unit. A process to be performed by the first wireless communication device 1 to be described below may be regarded as being performed by the control unit. In addition, a process to be performed by the second wireless communication device 2 to be described below may be regarded as being performed by the second control unit.

The first mode is a mode in which data communication may be performed. In the first mode, the first wireless communication device 1 is enabled to transmit data to the second wireless communication device 2 at any timing, for example.

The second mode is a mode in which limited data communication (e.g., communication of a limited data amount or communication in a limited time) may be performed. In the second mode, the first wireless communication device 1 is enabled to transmit data at timing at which the second wireless communication device 2 may receive the data, for example.

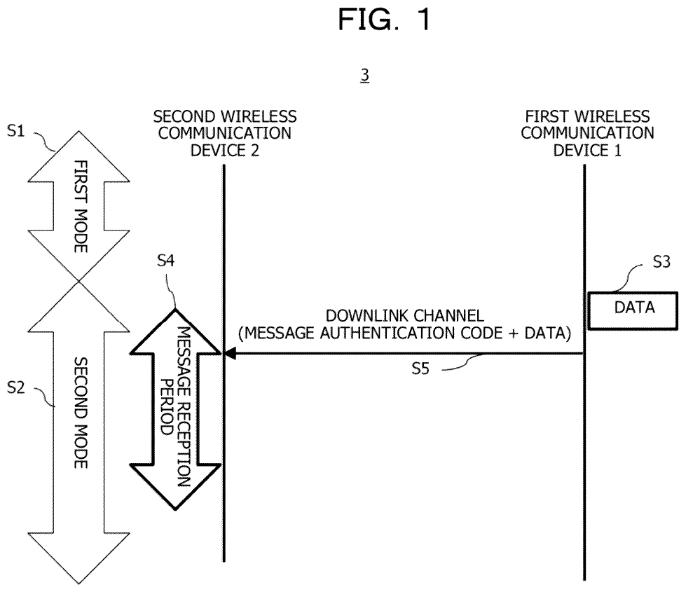

FIG. 1 is a diagram illustrating exemplary wireless communication in the wireless communication system 3. The second wireless communication device 2 transitions from the first mode (S1) to the second mode (S2). The transition from the first mode to the second mode is executed upon reception (transmission) of a predetermined message, for example.

During the second mode, data to be transmitted to the second wireless communication device 2 arrives (occurs) in the first wireless communication device 1 (S3). When the second wireless communication device 2 is enabled to receive the message (S4), the first wireless communication device 1 transmits the arrived data to the second wireless communication device 2 (S5).

The data is transmitted using a downlink channel. The downlink channel may include, in addition to the data, a code related to message authentication. The code related to the message authentication is a code that enables authentication of the contained message to be performed. A message with a message authentication code may be understood to be more secure than a message without a message authentication code.

Furthermore, the downlink channel may be transmitted without having a paired (corresponding) uplink channel. For example, the second wireless communication device 2 may transmit data and the like using the downlink channel without receiving the corresponding uplink channel (without receiving the uplink channel before or after the transmission).

The first wireless communication device 1 receives the downlink channel, and obtains the data. Then, the first wireless communication device 1 maintains the second mode (S2).

### Second Embodiment

A second embodiment will be described.

### <Wireless Communication System 10>

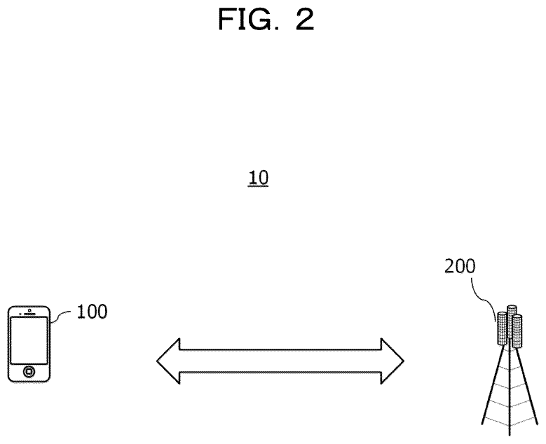

FIG. 2 is a diagram illustrating an exemplary configuration of a wireless communication system 10. The wireless communication system 10 includes a base station device 200 and a terminal device 100. The wireless communication system 10 is, for example, a wireless communication system that supports uplink and downlink SDT in an RRC_INACTIVE state.

The terminal device 100 is a communication device that is in wireless connection with the base station device 200 and exchanges data, and is, for example, a smartphone or a tablet terminal.

The base station device 200 supports, for example, various communication generations (e.g., 5G, Beyond 5G, etc.). Furthermore, the base station device 200 may be configured by one device, or may be configured by a plurality of devices such as a central unit (CU), a distributed unit (DU), and the like.

Note that, although there is one terminal device 100 in FIG. 2, there may be a plurality of terminal devices 100. Furthermore, while downlink small data transmission from the base station device 200 to the terminal device 100 will be described as an example in the following examples, similar processing may be applied to, for example, data transmission other than small data, uplink data transmission, and communication between terminal devices. Note that the small data is assumed to indicate, for example, data of equal to or smaller than a predetermined size. Furthermore, the predetermined size is assumed to be a size that may be transmitted in the scheme to be described below (e.g., size according to a channel size, radio frame size, etc.).

### <Exemplary Configuration of Terminal Device 100>

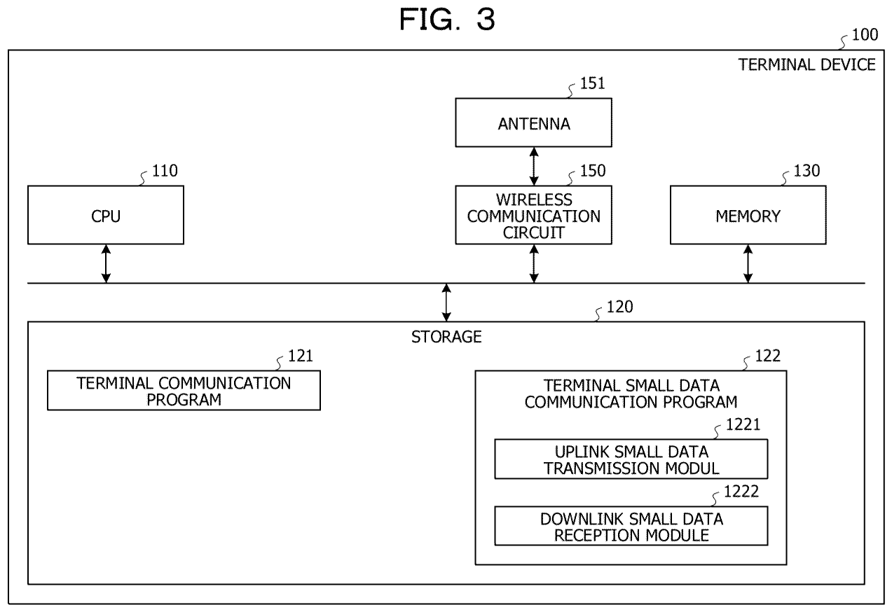

FIG. 3 is a diagram illustrating an exemplary configuration of the terminal device 100. The terminal device 100 includes a central processing unit (CPU) 110, storage 120, a memory 130, a wireless communication circuit 150, and an antenna 151.

The storage 120 is an auxiliary storage device that stores programs and data, such as a flash memory, a hard disk drive (HDD), a solid state drive (SSD), or the like. The storage 120 stores a terminal communication program 121 and a terminal-side small data communication program 122.

The memory 130 is an area into which the program stored in the storage 120 is loaded. Furthermore, the memory 130 may also be used as an area in which the program stores data.

The wireless communication circuit 150 is a device that wirelessly communicates with the base station device 200 or another terminal device 100. The wireless communication circuit 150 includes the antenna 151. The antenna 151 includes, for example, a directional antenna capable of controlling a direction of transmission and reception of radio waves.

The CPU 110 is a processor that constructs each unit to implement each type of processing by loading the program stored in the storage 120 into the memory 130 and executing the loaded program.

By executing the terminal communication program 121, the CPU 110 constructs a second communication unit to perform terminal communication processing. The terminal communication processing is processing of establishing wireless connection with the base station device 200 or another terminal device 100 to perform wireless communication.

The CPU 110 constructs a second control unit by executing the terminal-side small data communication program 122 to perform terminal-side small data communication processing. The terminal-side small data communication processing is processing for controlling transmission and reception of small data between the terminal device 100 and the base station device 200. The terminal device 100 supports each of uplink and downlink SDT schemes in the terminal-side small data communication processing. The uplink SDT scheme includes, for example, a 4-step RACH scheme, a 2-step RACH scheme, and a configured grant scheme. Details of the downlink SDT scheme will be described later.

The CPU 110 constructs the second control unit by executing an uplink small data transmission module 1221 included in the terminal-side small data communication program 122 to perform uplink small data transmission processing. The uplink small data transmission processing is processing when small data is generated in the terminal device 100 in the RRC_INACTIVE state, and is processing of transmitting the small data to the base station device 200. The uplink small data transmission processing supports the uplink SDT scheme.

The CPU 110 constructs the second control unit by executing a downlink small data reception module 1222 included in the terminal-side small data communication program 122 to perform downlink small data reception processing. The downlink small data reception processing is processing in a case where small data is generated in the base station device 200 when the terminal device 100 is in the RRC_INACTIVE state, and is processing of receiving the small data from the base station device 200. The downlink small data reception processing supports the downlink SDT scheme.

### <Exemplary Configuration of Base Station Device 200>

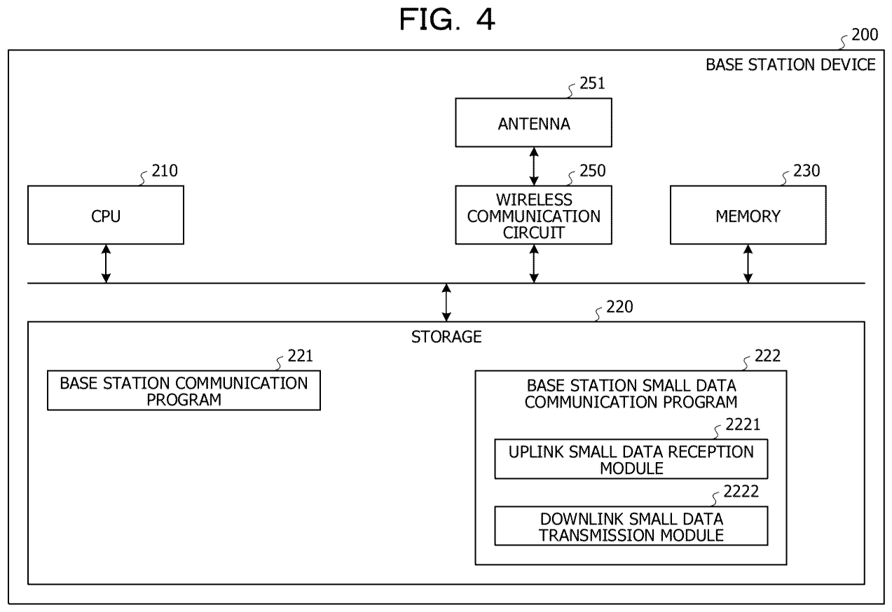

FIG. 4 is a diagram illustrating an exemplary configuration of the base station device 200. The base station device 200 includes a CPU 210, storage 220, a memory 230, a wireless communication circuit 250, and an antenna 251.

The storage 220 is an auxiliary storage device that stores programs and data, such as a flash memory, an HDD, an SSD, or the like. The storage 220 stores a base station communication program 221 and a base-station-side small data communication program 222.

The memory 230 is an area into which the program stored in the storage 220 is loaded. Furthermore, the memory 230 may also be used as an area in which the program stores data.

The wireless communication circuit 250 is a device that wirelessly communicates with the terminal device 100. The wireless communication circuit 250 includes the antenna 251. The antenna 251 includes, for example, a directional antenna capable of controlling a direction of transmission and reception of radio waves.

The CPU 210 is a processor that constructs each unit to implement each type of processing by loading the program stored in the storage 220 into the memory 230 and executing the loaded program.

By executing the base station communication program 221, the CPU 210 constructs a communication unit to perform base station communication processing. The base station communication processing is processing of wirelessly communicating with the terminal device 100. In the base station communication processing, the base station device 200 establishes wireless connection with the terminal device 100 to transmit data and control signals to the terminal device 100 and to receive data from the terminal device 100.

The CPU 210 constructs a control unit by executing the base-station-side small data communication program 222 to perform base-station-side small data communication processing. The base-station-side small data communication processing is processing for controlling transmission and reception of small data between the terminal device 100 and the base station device 200. The base station device 200 supports each of uplink and downlink SDT schemes in the base-station-side small data communication processing. The uplink SDT scheme includes, for example, a 4-step RACH scheme, a 2-step RACH scheme, and a configured grant scheme. Details of the downlink SDT scheme will be described later.

The CPU 210 constructs the control unit by executing an uplink small data reception module 2221 included in the base-station-side small data communication program 222 to perform uplink small data reception processing. The uplink small data reception processing is processing when small data is generated in the terminal device 100 in the RRC_INACTIVE state, and is processing of receiving the small data from the terminal device 100 The uplink small data reception processing supports the uplink SDT scheme.

The CPU 210 constructs the control unit by executing a downlink small data transmission module 2222 included in the base-station-side small data communication program 222 to perform downlink small data transmission processing. The downlink small data transmission processing is processing in a case where small data is generated in the base station device 200 when the terminal device 100 is in the RRC_INACTIVE state, and is processing of transmitting the small data to the terminal device 100. The downlink small data transmission processing supports the downlink SDT scheme.

### <Paging Cycle>

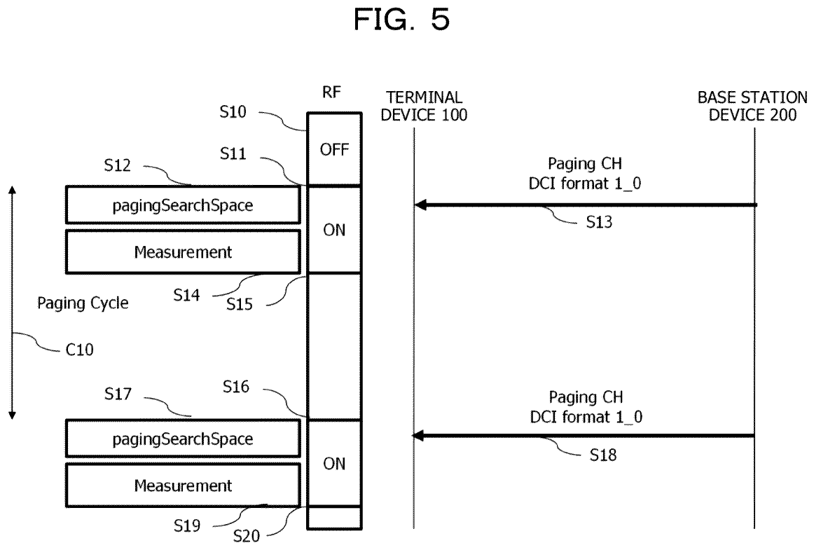

FIG. 5 is a diagram illustrating an exemplary paging cycle of the terminal device 100 in the RRC_INACTIVE state. The paging cycle indicates, for example, a cycle in which paging (e.g., RAN paging) is transmitted from the base station device 200.

In the RRC_INACTIVE state, the terminal device 100 turns off a radio unit (RF) (S10). The terminal device 100 turns on the radio unit in accordance with the timing of paging reception (S11). Then, the terminal device 100 searches for paging, and stands by for paging reception (S12).

The base station device 200 transmits paging at predetermined timing (S13). The paging is transmitted to the terminal device 100 of the same paging group, and includes, for example, a downlink control information (DCI) format 1_0.

The terminal device 100 receives the paging in the paging reception stand by state (S13). Then, the terminal device 100 performs measurement (S14), and turns off the radio unit (S15).

Then, the terminal device 100 turns on the radio unit again when the paging cycle has elapsed (S16), and repeats paging reception standby (S17), paging reception (S18), execution of measurement (S19), and turning off of the radio unit (S20).

In the RRC_INACTIVE state, the terminal device 100 turns on the radio unit according to the paging cycle and turns off the radio unit otherwise, thereby suppressing power consumption. Moreover, the terminal device 100 also performs measurement when the radio unit is turned on for paging reception. As a result, the terminal device 100 is enabled to suppress the number of times of on/off operation of the radio unit, and to suppress the power consumption.

### <Downlink SDT Scheme>

The downlink SDT scheme will be described. In the following descriptions, it is assumed that, as preconditions, downlink data (small data) to be transmitted to the terminal device 100 is generated in the base station device 200 and the terminal device 100 is in the RRC_INACTIVE state when the data is generated.

### <1. First Scheme>

A first scheme is a scheme in which the base station device 200 causes the terminal device 100 to transition to an RRC_CONNECTED state and transmits data.

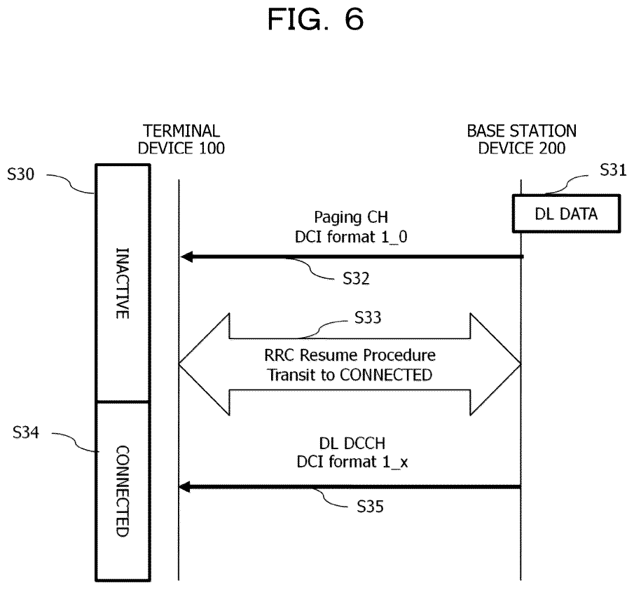

FIG. 6 is a diagram illustrating an exemplary sequence of the first scheme. The terminal device 100 is in the RRC_INACTIVE state (S30). The base station device 200 has downlink small data to be transmitted to the terminal device 100 (S31).

The base station device 200 transmits paging to the terminal device 100 (S32). The terminal device 100 turns on the radio unit to receive the paging.

Then, the base station device 200 executes a procedure for resuming the terminal device 100 and the radio resource control (RRC) (procedure for making transition from the RRC_INACTIVE state to the RRC_CONNECTED state) (S33), and causes the terminal device 100 to transition to the RRC_CONNECTED state (S34).

Then, the base station device 200 transmits the small data to the terminal device 100 in the RRC_CONNECTED state (S35).

### <2. Second Scheme>

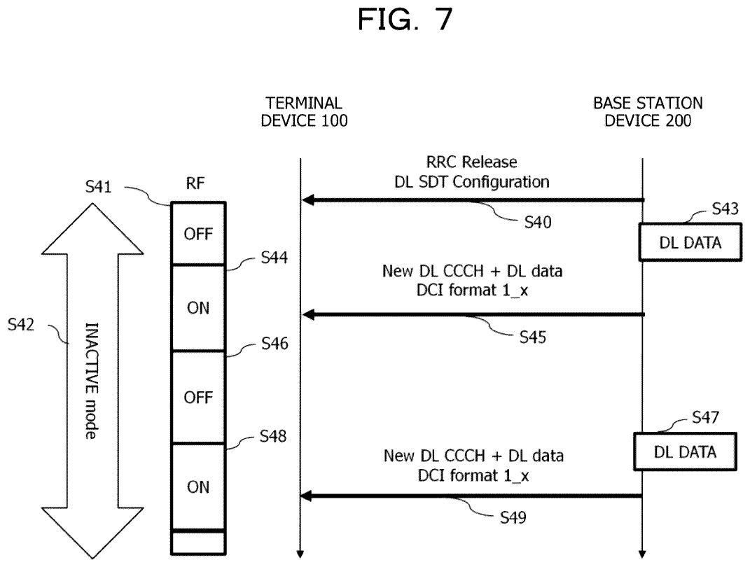

FIG. 7 is a diagram illustrating an exemplary sequence of a second scheme. The second scheme defines a new message for downlink data transmission. The new message is defined as, for example, a new downlink common control channel (which will be referred to as a New DL CCCH hereinafter).

The base station device 200 transmits an RRC Release (or an RRC Connection Release) (S40). The RRC Release is a message serving as a trigger for causing the terminal device 100 to transition to the RRC_INACTIVE state. The RRC Release includes, for example, information regarding the downlink SDT scheme. The information regarding the downlink SDT scheme includes, for example, all or a part of the downlink SDT scheme to be used, data transmission timing, information regarding the New DL CCCH, and the like. Note that the RRC Release is an example, and the message including the information regarding the downlink SDT scheme is not limited to this.

The terminal device 100 receives the RRC Release, performs predetermined processing (sequence), transitions to the RRC_INACTIVE state (S42), and turns off the radio unit (S41). When the terminal device 100 is in the RRC_INACTIVE state, small data to be transmitted to the terminal device 100 arrives at the base station device 200 (S43).

For example, the terminal device 100 turns on the radio unit at the timing of receiving paging (S44). The base station device 200 transmits the data using the New DL CCCH in accordance with the timing at which the terminal device 100 turns on the radio unit (S45).

The terminal device 100 searches for a New DL CCCH when the radio unit is on, and receives the transmitted New DL CCCH (S45). Then, the terminal device 100 turns off the radio unit when the predetermined processing is complete (S46). The terminal device 100 is enabled to receive the small data while maintaining the RRC_INACTIVE state.

Furthermore, when the small data to be transmitted in the RRC_INACTIVE state arrives (S47), the base station device 200 transmits, in accordance with the timing at which the terminal device 100 turns on the radio unit (S48), the data using the New DL CCCH (S49). The terminal device 100 searches for a New DL CCCH when the radio unit is on, and receives the transmitted New DL CCCH (S49).

As a result, the terminal device 100 is enabled to receive the small data while maintaining the RRC_INACTIVE state.

Note that the CCCH may not be regarded as a secure message (channel) in the RAN conforming to 3GPP. The New DL CCCH makes a message secure by, for example, having a message authentication code such as MAC-I. Since the New DL CCCH includes a message authentication code, it may be regarded as a more secure message as compared with, for example, paging that is transmitted to unspecified number of destinations and does not have an authentication code.

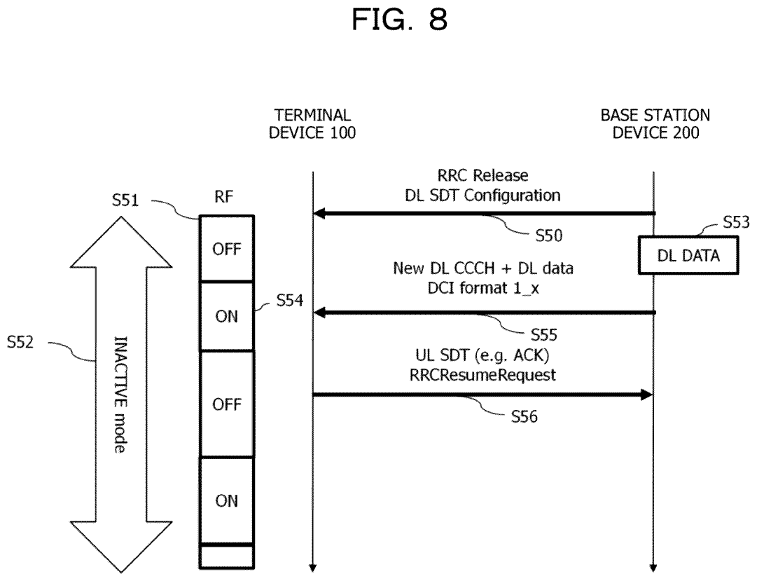

FIG. 8 is a diagram illustrating an exemplary sequence of the second scheme. The terminal device 100 in the sequence of FIG. 8 is capable of (may) transmitting acknowledgement (ACK) to data received through the New DL CCCH. A process of S50 to S55 is similar to the process of S40 to S45 in FIG. 7.

When data is successfully received, the terminal device 100 transmits ACK to the base station device 200 (S56). At this time, the terminal device 100 uses the uplink SDT scheme for the ACK transmission. The terminal device 100 transmits, for example, an RRC Resume Request including ACK (small data) to the base station device 200 using any one of uplink SDT schemes (S56).

In the second scheme, the base station device 200 is enabled to transmit the small data while maintaining the RRC_INACTIVE state of the terminal device 100. Furthermore, since the New DL CCCH has a message authentication code, data transmission using old security settings (security settings already adopted) is enabled without performing a security (concealment) procedure.

### <3. Third Scheme>

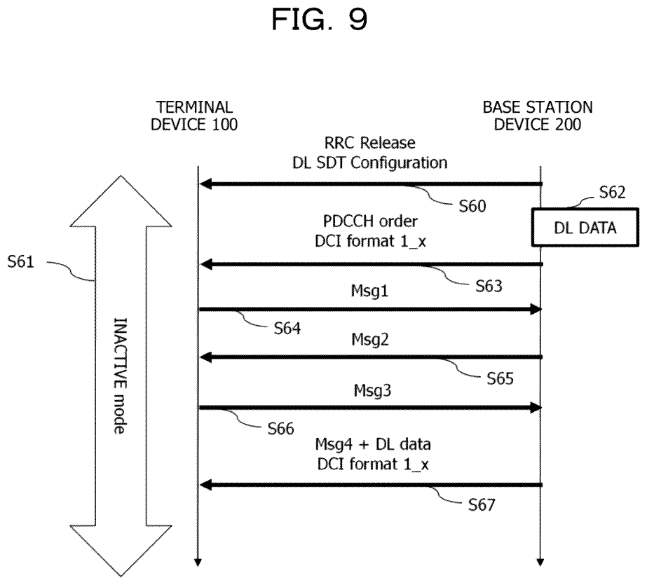

FIG. 9 is a diagram illustrating an exemplary sequence of a third scheme. According to the third scheme, the base station device 200 transmits small data using a physical downlink control channel (PDCCH) order.

The base station device 200 transmits an RRC Release (S60). The RRC Release includes, for example, information regarding the downlink SDT scheme.

The terminal device 100 receives the RRC Release, performs predetermined processing (sequence), transitions to the RRC_INACTIVE state (S62), and turns off the radio unit. When the terminal device 100 is in the RRC_INACTIVE state, small data to be transmitted to the terminal device 100 arrives at the base station device 200 (S62).

The base station device 200 transmits a PDCCH order (S63). The PDCCH order is a message serving as a trigger for causing the terminal device 100 to execute random access (RA).

Upon reception of the PDCCH order, the terminal device 100 transmits Msg1 to the base station device 200 (S64). The Msg1 is, for example, an RA preamble.

Upon reception of the Msg1 (S64), the base station device 200 transmits Msg2 to the terminal device 100 (S65). The Msg2 is, for example, an RA response corresponding to the Msg1.

Upon reception of the Msg2 (S65), the terminal device 100 transmits Msg3 to the base station device 200 (S66). The Msg3 is, for example, an RRC message of a layer 3, and includes identification information and authentication information of the terminal device 100. The Msg3 is, for example, Scheduled Transmission.

Upon reception of the Msg3 (S66), the base station device 200 transmits Msg4 including the small data to the terminal device 100 (S67). The Msg4 is, for example, a message for controlling the state of the terminal device 100. The Msg4 is, for example, Contention Resolution.

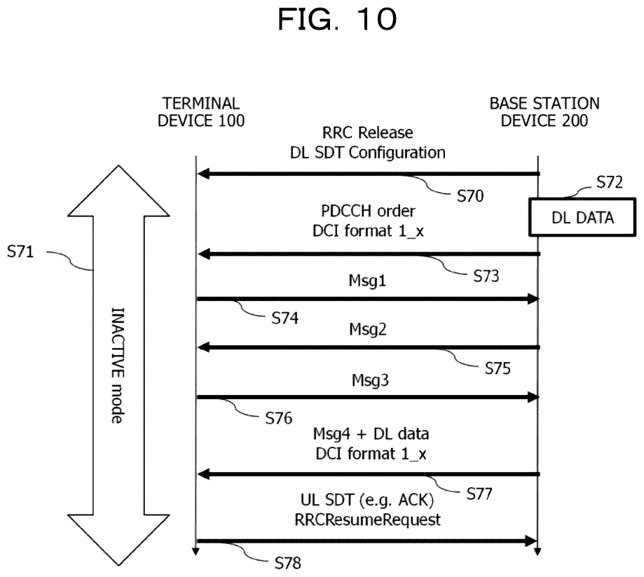

FIG. 10 is a diagram illustrating an exemplary sequence of the third scheme. The terminal device 100 in the sequence of FIG. 10 transmits acknowledgement (ACK) to the data received in the Msg4. A process of S70 to S77 is similar to the process of S60 to S67 in FIG. 9.

When data is successfully received, the terminal device 100 transmits ACK to the base station device 200 (S78). At this time, the terminal device 100 uses the uplink SDT scheme for the ACK transmission. The terminal device 100 transmits, for example, an RRC Resume Request including ACK (small data) to the base station device 200 using any one of the uplink SDT schemes (S78).

In the third scheme, the base station device 200 is enabled to transmit the small data using a physical sidelink control channel (PSCCH) order. The terminal device 100 is enabled to receive the small data while maintaining the RRC_INACTIVE state.

### <Variation of Second Scheme>

In the second scheme, the base station device 200 transmits the New DL CCCH at the timing of turning on the radio unit at the paging reception timing. In a variation, a transmission trigger other than the paging-triggered data transmission. For example, semi-persistent scheduling (SPS)-triggered data transmission is defined.

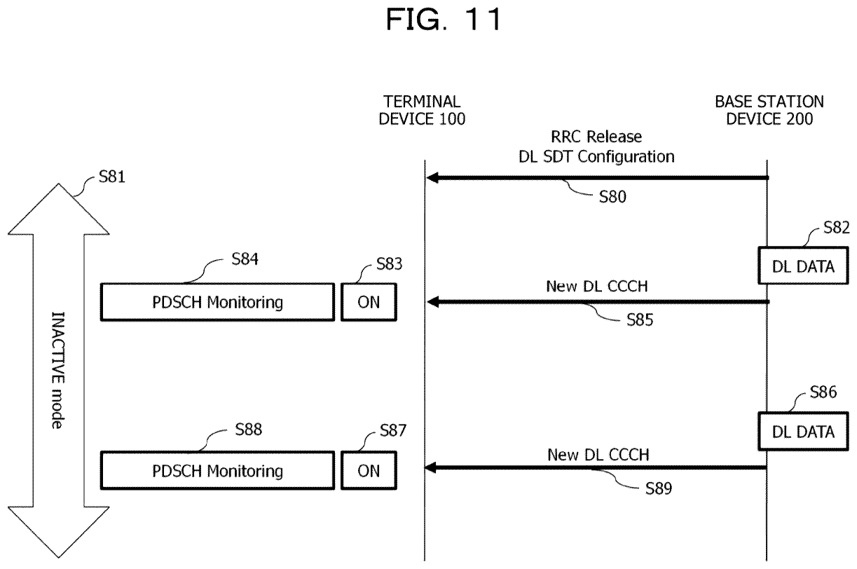

FIG. 11 is a diagram illustrating an example of the SPS-triggered data transmission. The base station device 200 transmits an RRC Release (or an RRC Connection Release) (S80). The RRC Release includes, for example, information regarding the downlink SDT scheme.

The terminal device 100 receives the RRC Release, performs predetermined processing (sequence), transitions to the RRC_INACTIVE state (S81), and turns off the radio unit. When the terminal device 100 is in the RRC_INACTIVE state, small data to be transmitted to the terminal device 100 arrives at the base station device 200 (S82).

The terminal device 100 turns on the radio unit (S83) at the timing of SPS message reception, and searches for a PDSCH (S84).

The base station device 200 transmits, to the terminal device 100, a New DL CCCH including the small data in accordance with the timing at which the terminal device 100 turns on the radio unit in the SPS (S85). Thereafter, the base station device 200 repeats a similar process when data is generated (process S86 to S89).

### <Paging Cycle According to Downlink SDT Scheme>

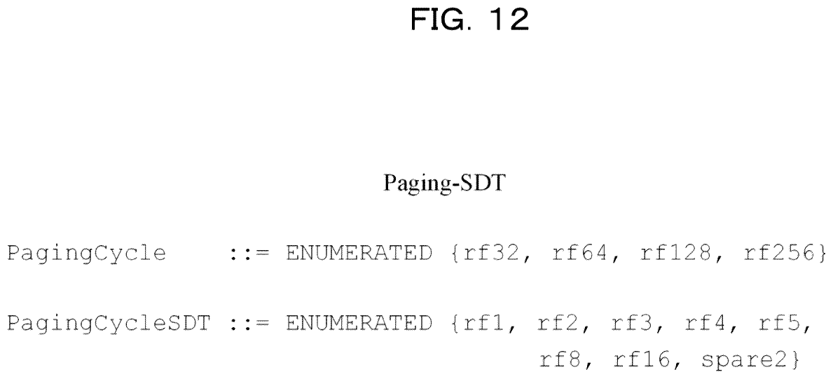

A paging cycle according to the downlink SDT scheme is defined to support the paging-triggered SDT. FIG. 12 is a diagram illustrating an exemplary paging cycle according to the downlink SDT scheme. In FIG. 12, “PagingCycle” indicates an exemplary paging cycle in already existing RAN paging, and “PagingCycleSDT” indicates an exemplary paging cycle according to the downlink SDT scheme.

For example, an interval shorter than that of the PagingCycle may be needed for the PagingCycleSDT. Thus, an interval shorter than that of the PagingCycle is defined in the PagingCycleSDT. The PagingCycleSDT supports an interval (e.g., rf5) according to a transmission cycle of measurement signals, rf16 not commonly supported, or the like. Note that the spare is not necessarily needed. If there is another useful value, for example, rf24 as an intermediate value between rf16 and rf32 may be added. The rf24 is an example.

### <SPS Period According to Downlink SDT Scheme>

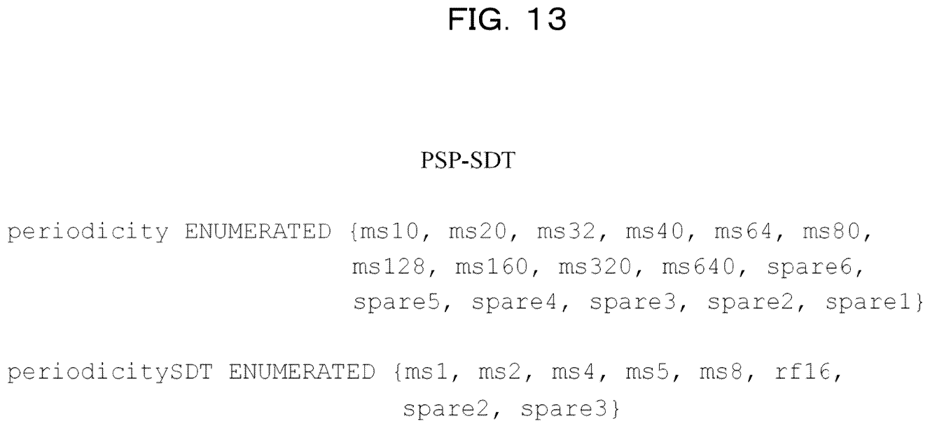

An SPS period according to the downlink SDT scheme is defined to support the SPS-triggered SDT. FIG. 13 is a diagram illustrating an example of the SPS period according to the downlink SDT scheme. In FIG. 13, “periodicity ENUMERATED” indicates an example of an already existing SPS period, and “periodicitySDT ENUMERATED” indicates an example of the SPS period according to the downlink SDT scheme.

For example, an interval shorter than that of the periodicity ENUMERATED may be needed for the periodicitySDT ENUMERATED. Thus, an interval shorter than that of the periodicity ENUMERATED is defined in the periodicitySDT ENUMERATED.

The SPS period according to the downlink SDT scheme is shorter than a scheduling period (quasi-static scheduling period) in the RRC Connected state, for example.

### <Calculation Formula of HARQ Process ID>

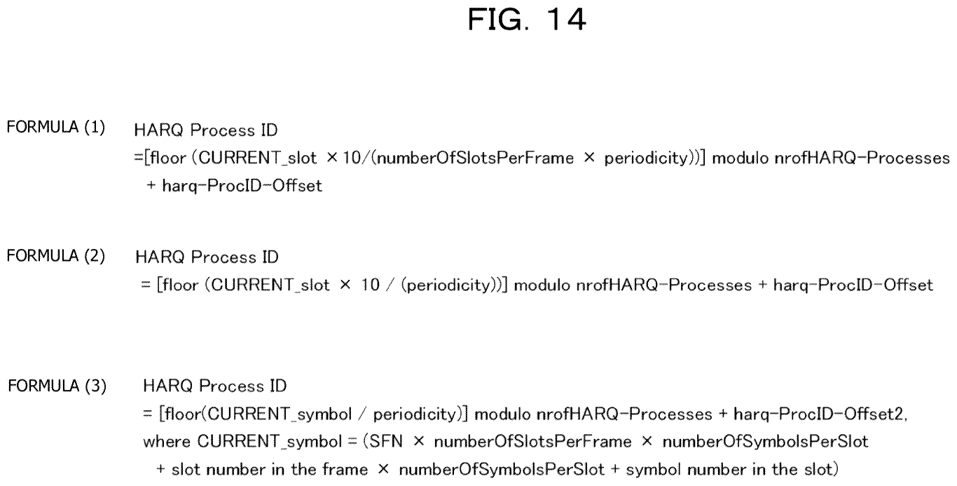

FIG. 14 is a diagram illustrating exemplary calculation formulae of a HARQ process ID. The HARQ process ID is, for example, an identifier for identifying data. The HARQ process ID is included in, for example, the New DL CCCH. Furthermore, for example, the HARQ process ID accompanies data. As described above, when the periodicity corresponds to a shorter period (e.g., shorter than 10 msec), the calculation formula of the HARQ process ID also needs to correspond to a period shorter than 10 msec. Note that the spare is not necessarily needed. If there are other useful values, for example, rf6, rf7, and rf9 may be added. Those values are examples.

The formula (1) is an example of a common HARQ process ID calculation formula.

The formula (2) is an example of a new HARQ process ID calculation formula. The formula (2) does not use numberOfSlotsPerFrame (e.g., number of consecutive slots included in one radio frame) for calculation.

The formula (3) is an example of a new HARQ process ID calculation formula. The formula (3) is a calculation formula using a calculation formula of configured grant (CG).

According to the formula (1), identifiers of an HARQ process shorter than 10 ms have the same value, and thus each HARQ process may not be identified. According to the formulae (2) and (3), identifiers of an HARQ process shorter than 10 ms have different values, and thus each HARQ process may be identified.

### <Configuration of New DL CCCH>

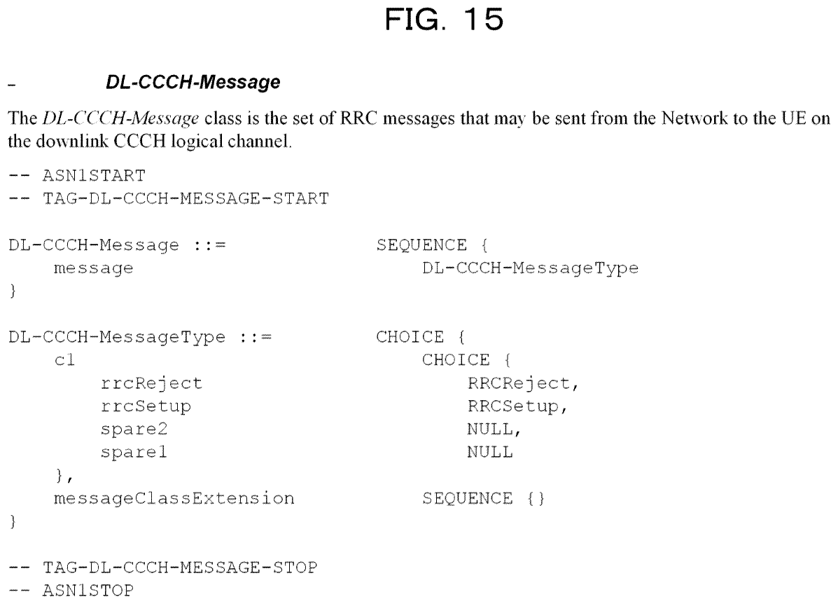

FIG. 15 is a diagram illustrating an exemplary configuration of the New DL CCCH. The New DL CCCH may be defined as, for example, a small data CCCH. The New DL CCCH is defined as, for example, SRB1. The New DL CCCH uses, for example, one spare bit. Unlike other DL-CCCHs, the New DL CCCH is a DL-CCCH that the base station device 200 may immediately transmit (there is no paired UL-CCCH).

The New DL CCCH includes, for example, the following information elements.
I-RNTI (40 bits) or Short-I-RNTI (24 bits): I-RNTI and Short-I-RNTI are identifiers (identification information) for identifying the terminal device 100. They are used to identify the terminal device 100.
resumeMAC-I (16 bits): it is used to authenticate a message (to improve security). It is an example of the message authentication code.
DL data: data to be transmitted (small data)

Note that the base station device 200 may determine whether or not data may be transmitted by SDT depending on a size of the data.

Furthermore, the base station device 200 performs, for example, protocol setting of a layer 2 on the terminal device 100 using the RRC Release. The base station device 200 includes, for example, a parameter of PDCP/RLC/MAC entity for SRB1 or the like in the RRC Release. Note that, for example, DefaultConfig may be used for some parameters.

Furthermore, the terminal device 100 may autonomously resume (restart) the layer 2 at the timing of performing the downlink SDT. At this time, it is sufficient if the terminal device 100 autonomously perform the procedure described in TS38.331 Section 5.3.13.3.

### OTHER EMBODIMENTS

The respective requirements described in the first embodiment, second embodiment, and other embodiments may be combined. Furthermore, the requirements described in the first embodiment, second embodiment, and other embodiments may be selectively used according to, for example, a wireless state, a system requirement, and the like.

All examples and conditional language provided herein are intended for the pedagogical purposes of aiding the reader in understanding the disclosure and the concepts contributed by the inventor to further the art, and are not to be construed as limitations to such specifically recited examples and conditions, nor does the organization of such examples in the specification relate to a showing of the superiority and inferiority of the disclosure. Although one or more embodiments of the present disclosure have been described in detail, it should be understood that the various changes, substitutions, and alterations could be made hereto without departing from the spirit and scope of the disclosure.

What is claimed is:

1. A first wireless communication device comprising:
a controller configured to:
operate in a first mode or a second mode, the first mode being a mode that has a first mode in which data communication with a second wireless communication device may be performed, the second mode being a mode in which limited data communication may be performed; and
transmit, at timing when the second wireless communication device may receive data in the second mode, a code related to message authentication and first data, to the second wireless communication device via a downlink channel, by allocating the code related to message authentication and the first data to the downlink channel that does not accompany a corresponding uplink channel.

2. The first wireless communication device according to claim 1, wherein
the timing when the first data may be received in the second mode has a cycle shorter than a cycle of calling the second wireless communication device.

3. The first wireless communication device according to claim 1, wherein
the timing when the first data may be received in the second mode has a cycle shorter than a cycle of quasi-static scheduling that may be set in the first mode.

4. The first wireless communication device according to claim 3, wherein
the first data includes an identifier that may identify the first data.

5. The first wireless communication device according to claim 1, wherein
the downlink channel includes identification information that identifies the second wireless communication device.

6. The first wireless communication device according to claim 1, wherein
the second mode includes a mode in which the second wireless communication device activates a radio unit that may receive the data at predetermined timing and stops the radio unit when a series of processing at the predetermined timing is complete.

7. The first wireless communication device according to claim 6, wherein
the first mode includes a mode in which the second wireless communication device does not stop the radio unit.

8. The first wireless communication device according to claim 6, wherein
the second mode includes an RRC_INACTIVE state.

9. The first wireless communication device according to claim 8, wherein
the first mode includes an RRC_CONNECTED state.

10. The first wireless communication device according to claim 1, wherein
the first data includes data of equal to or smaller than a predetermined size.

11. A second wireless communication device comprising:
a second controller configured to:
operate in a first mode or a second mode, the first mode being a mode in which data communication with a first wireless communication device may be performed, the second mode being a mode in which limited data communication may be performed; and
receive, at timing when the first wireless communication device may receive data in the second mode, a downlink channel that does not accompany a corresponding uplink channel and includes a message authentication code and first data.
